(19) United States
(12) Patent Application Publication
(10) Pub. No.: US 2018/0001360 A1
(43) Pub. Date: Jan. 4, 2018

(54) ROLLER FOR A METALLURGICAL PLANT

(71) Applicant: SIEMENS VAI METALS TECHNOLOGIES GMBH, LINZ (AT)

(72) Inventor: Gerald Hohenbichler, Kronstorf (AT)

(21) Appl. No.: 15/539,784

(22) PCT Filed: Dec. 3, 2015
(86) PCT No.: PCT/EP2015/078526

§ 371 Date: Jun. 26, 2017

(30) Foreign Application Priority Data
Dec. 29, 2014 (DE) 10 2014 226 998.9

(51) Int. Cl. B21B 37/32; B65G 13/06; B21B 27/05; B21B 39/10; B21B 27/08; B22D 11/128; B22D 11/06; B21B 37/42

(52) U.S. Cl. CPC B21B 37/32; B21B 27/08; B65G 13/065; B22D 11/1287; B21B 27/05; B21B 39/10; B21B 37/42; F16C 2322/12; B22D 11/0651

(57) ABSTRACT

A roller for a metallurgical plant is provided. The roller is modified in such a way that the camber thereof can be set in a simple and robust manner. The roller axle is connected to the roller shell at one point, preferably at at least two points, via a ring, and the ring has a heating element, wherein the height H of the ring can be changed by ΔH as a result of the heating of the heating element.

### CROSS-REFERENCE TO RELATED APPLICATIONS

This application claims priority to PCT Application No. PCT/EP2015/078526, having a filing date of Dec. 3, 2015, which is based upon and claims priority to DE Application No. 10 2014 226 998.9, having a filing date of Dec. 29, 2014 the entire contents both of which are hereby incorporated by reference.

### FIELD OF TECHNOLOGY

The following relates to a roller for a metallurgical plant, such as a strand guide roller for guiding a metallic strand, preferably composed of steel, in a continuous casting machine, or a guide roller for guiding a metallic strip in a hot rolling mill or through a metallic bath, preferably composed of zinc, for electrolytically coating the strip, having:
a rotatable roller axle; and
   a roller shell which surrounds the roller axle.

### BACKGROUND

The following does not expressly relate to a casting roller for strip casting a metallic strip through two counterrotating casting rollers. The casting of a metallic strip through two casting rollers is referred to as twin roll casting. Here, a meniscus forms between two driven casting rollers and a fully solidified strip forms at the kissing point between the casting rollers, which strip is drawn out continuously therethrough.

A casting roller for strip casting is known from WO 2008/061635 A1, the camber of which can be set by hydraulic pressure pads between the roller axle and the roller shell. Since embodiments of this invention do not extend to casting rollers for twin roll casting, said document cannot represent the closest prior art.

### SUMMARY

An aspect relates to a roller for a metallurgical plant, such as a strand guide roller or a guide roller in a hot rolling mill, the camber of which roller can be set in a simple and robust way. This either allows the profile of a strand or of a strip guided by the roller to be influenced or allows the profile of the roller itself to be influenced.

In one case, it is possible to improve the quality of the strand or of the strip, and in the other case, it is possible to compensate for or reduce unwanted thermal expansion of the roller.

Specifically, in the case of the roller initially mentioned, the object is achieved in that the roller axle is connected to the roller shell at a point, preferably at at least two points, via a ring, and the ring has a heating element, wherein the height H of the ring can be changed by ΔH as a result of the heating of the heating element.

The heating element allows the temperature and consequently the height of the ring to be changed. In contrast to mechanical or hydraulic actuators between the roller axle and the roller shell, a ring with a heating element is very simple and robust and particularly insensitive to high temperatures, such as those that typically occur in a continuous casting plant or in a hot rolling mill. Even piezoelectric actuators are little suited to set the profile of a roller, on account of the high temperatures.

The change ΔH in the height of a ring is ΔH=H₀.α.ΔT, where H₀ is the height of the ring prior to the change in temperature, α is the coefficient of linear thermal expansion and ΔT is the change in temperature effected by the heating element. For example, in the case of stainless steel, the coefficient of linear thermal expansion is α=17.10⁻⁶ 1/° C. The change in height of the ring(s) allows the camber of the roller to be set selectively.

The height of the ring can be set in a particularly simple manner if the heating element is an electrical heating element, e.g. a resistance heating wire.

The design of the roller is little changed if the heating element is at least partially, preferably completely, spatially integrated into the ring.

In the case of electrical heating elements in particular, it is expedient if the roller has a slip ring and has a line from the slip ring to the heating element, such that electric current can be passed from the slip ring to the heating element via the line.

Embodiments of the invention are not limited to rollers with a continuous roller axle and can also be applied in the same manner for rollers in which the roller axle is formed from two axle journals.

Concerning the application of embodiments of the invention in a continuous casting plant or in a hot rolling mill, it is advantageous if the roller is a roller which is internally cooled by a cooling medium. Moreover, it is possible for the roller, or even the strand or the strip outside the roller, to be cooled by cooling agent.

Here, it is expedient if the roller axle has a preferably central channel for a cooling agent.

In order to thermally insulate the point at which the ring bears on the roller shell from the rest of the roller shell, it is advantageous if a water guide element for guiding the cooling agent is arranged between the roller shell and the roller axle, wherein the cooling agent can be guided preferably in the axial direction, particularly preferably in a spiral manner in the axial and the radial direction, along the inner surface of the roller shell.

Preferably, the roller has a temperature sensor for measuring the actual temperature of the ring and has a measurement line for passing a measurement signal from the temperature sensor to a further slip ring. The temperature measurement allows the actual change in height of the ring to be determined sufficiently precisely.

Here, it is advantageous if an analog or digital amplifier for amplifying a signal of the temperature sensor is integrated into the roller, and the amplifier is preferably cooled by the cooling medium. This allows the signal level of the temperature signal (e.g. the voltage value of a thermal element) to be increased such that the temperature signal is little disturbed by external electric or magnetic fields.

In an expedient arrangement, the point at which the roller axle is connected to the roller shell via a ring is arranged in an end region of the roller shell. Since a symmetrical profile of the strand or of the strip is usually desired, it is expedient if the roller axle is connected to the roller shell via two rings which are arranged symmetrically with respect to a central plane of the roller.

### BRIEF DESCRIPTION

Some of the embodiments will be described in detail, with reference to the following figures, wherein like designations denote like members, wherein:

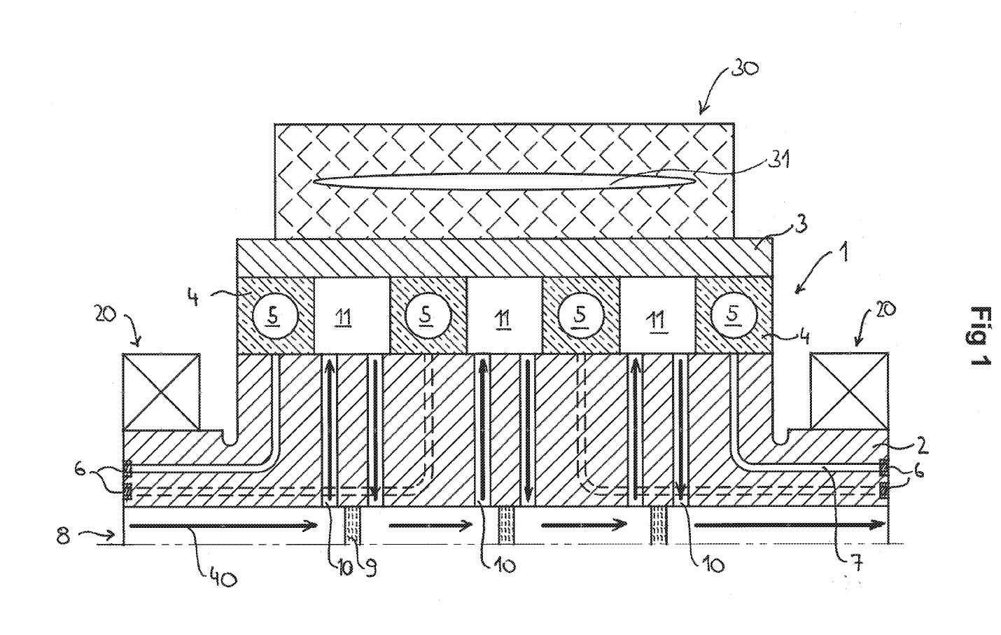

FIG. 1 shows a section through a strand guide roller according to embodiments of the invention having two bearings without bearing blocks, in accordance with embodiments of the present invention;

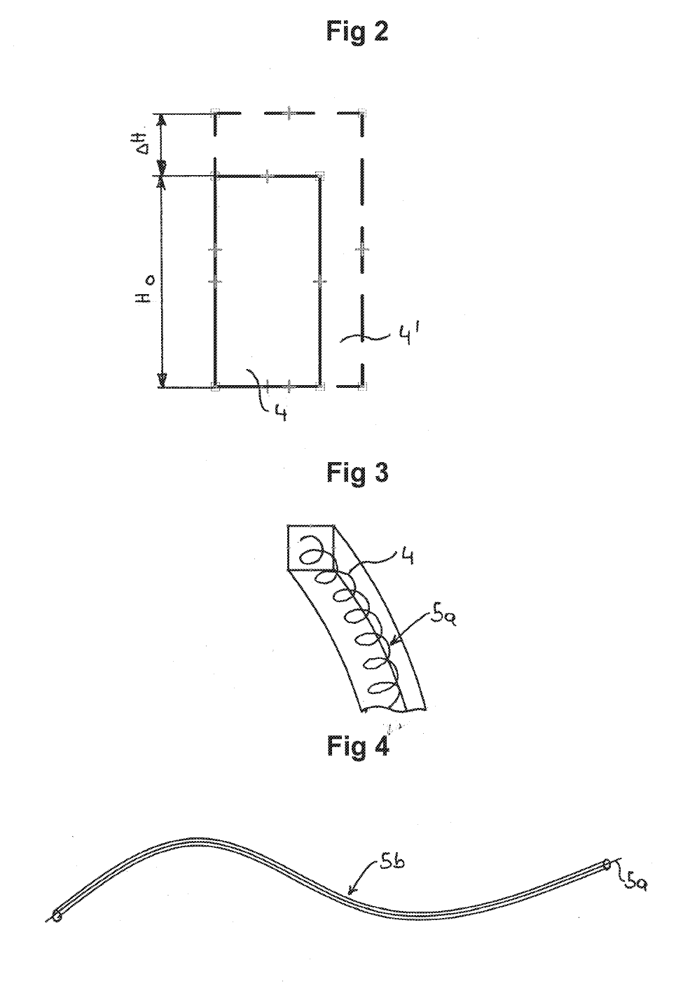

FIG. 2 shows a diagrammatic illustration of the expansion of a ring by way of a heating element, in accordance with embodiments of the present invention;

FIG. 3 shows a ring having a heating element, in accordance with embodiments of the present invention;

FIG. 4 shows an electrical heating element having electrical insulation, in accordance with embodiments of the present invention; and

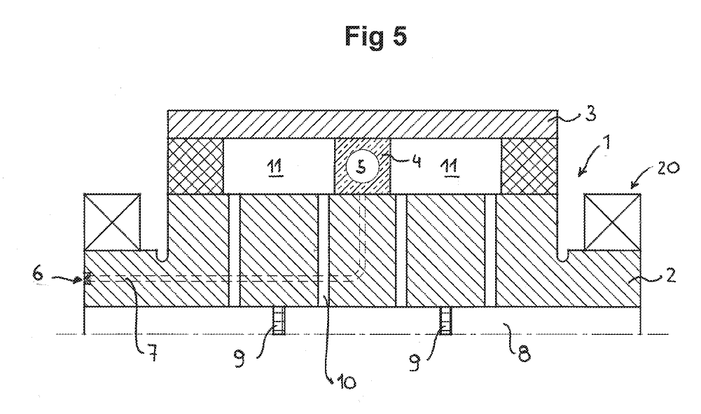

FIG. 5 shows a section through a strand guide roller according to embodiments of the invention having a single ring, in accordance with embodiments of the present invention.

### DETAILED DESCRIPTION

FIG. 1 diagrammatically shows in a sectional illustration the upper half of a roller 1 according to embodiments of the invention which guides a partly solidified strand 30, composed of steel and with a liquid core 31, in a continuous casting machine. The roller 1 is mounted rotatably by way of two bearings 20—here, roller bearings—which are supported on bearing blocks (not shown). The rotatable, continuous roller axle 2 has a central channel 8 for guiding a cooling medium 40 such as water; the path of the cooling medium through the internally cooled roller 1 is indicated by arrows. Between the rotatable roller axle 2 and the cylindrical roller shell 3 there are arranged four rings 4 into which in each case an electrical heating element 5 is integrated (see also FIG. 3 with an illustration of the spiraled heating wire 5a in the ring 4). Each ring 4 is supplied with electrical energy via a slip ring 6 and a line 7 such that the temperature of the ring can be set precisely. The change in height ΔH of the ring 4 can be set precisely via the temperature of the ring 4, such that for example an unwanted deflection of the roller shell 3, on account of the ferrostatic pressure of the strand 30 and the temperature-induced expansion, can be reduced or compensated. In order to avoid a so-called hydraulic short circuit of the cooling medium 40, three plugs 9 are arranged in the interior of the central channel 8 such that the cooling medium is forced to flow through the substantially radial branch lines 10 to the water jacket 11, in order there to remove a maximum possible amount of heat from the red-hot strand 30. In the illustrated embodiment, the ring is connected to the roller axle 2 and to the roller shell by way of in each case a press fit. As an alternative to this, in the case of relatively large expansions ΔR of the ring, it would be possible to provide a sealing element—for example, an O-ring—in the sealing joints between the roller axle 2 and the ring 4 and the roller shell 3 and the ring 4. As a result of the heating of a heating element 5 in the ring 4, the ring is heated such that the height of the ring increases by ΔH=H₀.α.ΔT. In the case of a ring height H₀=50 mm and a coefficient of linear thermal expansion of α=17.10⁻⁶ 1/° C., a change in temperature of 100° C. results in a change in radius ΔH=85 μm. Here, it is interesting that materials such as Al or Mg can, on account of their large coefficient of thermal expansion, be of interest as materials for the ring 4, especially since, for example, Mg has a coefficient of thermal expansion which is more than double that of pure Fe.

FIG. 2 diagrammatically shows the thermal expansion of a ring 4, which has a height H₀ at a temperature T₀, to a ring 4′, which has a height H=H₀+ΔH at a temperature T=T₀+ΔT, where it holds that ΔH=H₀.α.ΔT.

FIG. 3 diagrammatically shows a segment of a ring 4 having an integrated electrical heating element 5a. The heating element 5a is completely integrated into the ring 4 and is of spiral design.

FIG. 4 shows an electrical heating element 5a having electrical insulation 5b.

Finally, FIG. 5 shows in a sectional illustration the upper half of a roller for guiding a strip through a zinc bath. Unlike FIG. 1, the roller axle is connected only at one point—namely in the center of the roller 1—to the roller shell 3 via a ring 4 having a heating element 5. As a result of the heating of the ring 4 by means of the electrical heating device 5, the height of the ring can again be adapted such that for example the deflection of the roller shell 3 can be compensated or reduced.

Although the invention has been described and illustrated in detail by way of the preferred exemplary embodiment, the invention is not restricted by the disclosed examples and other variations can be derived herefrom by a person skilled in the art without departing from the scope of protection of the invention.

For the sake of clarity, it is to be understood that the use of ‘a’ or ‘an’ throughout this application does not exclude a plurality, and ‘comprising’ does not exclude other steps or elements.

### LIST OF REFERENCE SIGNS

1 Roller
2 Roller axle
3 Roller shell
4, 4′ Ring
5 Heating element
5a Electrical heating element
5b Electrical insulation
6 Slip ring
7 Line
8 Central channel
9 Plug
10 Branch line
11 Water jacket
20 Bearing
30 Strand
31 Liquid core
40 Cooling medium
H Height of ring
ΔH Change in height of ring

1. A roller for a metallurgical plant, such as a strand guide roller for guiding a metallic strand, composed of steel, in a continuous casting machine, or a guide roller for guiding a metallic strip in a hot rolling mill or through a metallic bath, composed of zinc, for electrolytically coating the metallic strip, with the exception of a casting roller for strip casting a metallic strip through two counterrotating casting rollers, comprising:
a rotatable roller axle;
a roller shell which surrounds the roller axle;
wherein the roller axle is connected to the roller shell at at least two points, via a ring, and the ring has a heating element, wherein the height of the ring can be changed by ΔH as a result of the heating of the heating element.

2. The roller as claimed in claim 1, wherein the heating element is an electrical heating element.

3. The roller as claimed in claim 1, wherein the heating element is at least one of partially and completely, spatially integrated into the ring.

4. The roller as claimed in claim 1, wherein the roller has a slip ring and has a line from the slip ring to the heating element, such that electric current can be passed from the slip ring to the heating element via the line.

5. The roller as claimed in claim 1, wherein the roller axle extends over an entire length of the roller.

6. The roller as claimed in claim 1, wherein the roller axle has two axle journals.

7. The roller as claimed in claim 1, wherein the roller is a roller which is internally cooled by a cooling medium.

8. The roller as claimed in claim 7, wherein the roller axle has a central channel for a cooling agent.

9. The roller as claimed in claim 8, wherein a water guide element for guiding the cooling agent is arranged between the roller shell and the roller axle, wherein the cooling agent can be guided in an axial direction, in a spiral manner in the axial direction and a radial direction, along an inner surface of the roller shell.

10. The roller as claimed in claim 1, wherein the roller has a temperature sensor for measuring an actual temperature of the ring and has a measurement line for passing a measurement signal from the temperature sensor to a further slip ring.

11. The roller as claimed in claim 10, wherein an analog or digital amplifier for amplifying a signal of the temperature sensor is integrated into the roller, and the amplifier is cooled by a cooling medium.

12. The roller as claimed in claim 1, wherein the ring is thermally insulated from the roller shell.

13. The roller as claimed in claim 1, wherein the ring is arranged in an end region of the roller shell.

14. A system comprising a roller as claimed in claim 1, having a current source and having a line from the current source to the slip ring of the roller.

15. The system as claimed in claim 14, having a temperature regulator which has a setpoint temperature input and an actual temperature input, and having a measurement line from the further slip ring to the actual temperature input, wherein the current source is set by the temperature regulator such that the actual temperature corresponds to the setpoint temperature to the maximum possible extent.
